(19) United States
(12) Patent Application Publication
(10) Pub. No.: US 2026/0273842 A1
(43) Pub. Date: Sep. 17, 2026

(54) Laser-Based Part Manufacturing Method with Reduced Sloshing and Spatter

(71) Applicant: Seurat Technologies., Inc., Wilmington, MA (US)

(72) Inventors: Behzad Fotovvati, Billerica, MA (US); Subin Shrestha, Dracut, MA (US); Nicholas Charles Ferreri, Eliot, ME (US); Ning Duanmu, Nashua, NH (US); Andrew J. Bayramian, Marblehead, MA (US)

(21) Appl. No.: 19/568,317

(22) Filed: Mar. 16, 2026

Related U.S. Application Data
(60) Provisional application No. 63/773,185, filed on Mar. 17, 2025.

(51) Int. Cl. B29C 64/188; B22F 10/28; B22F 10/50; B22F 10/85; B28B 1/00; B28B 17/00; B29C 64/153; B29C 64/393; B33Y 10/00; B33Y 40/00; B33Y 50/02; C03B 19/01

(52) U.S. Cl. CPC B29C 64/188; B22F 10/28; B22F 10/50; B22F 10/85; B28B 1/001; B28B 17/0081; B29C 64/153; B29C 64/393; B33Y 10/00; B33Y 40/00; B33Y 50/02; C03B 19/01; B22F 2998/10

(57) ABSTRACT

A method of laser manufacturing configured to reduce internal and external part imperfections arising from spatter and sloshing comprising a variety of elements including but not limited to a combination of high flux pulsed laser and low flux melting laser, selectively irradiating, and introducing a spatial flux. Placing a high flux pulse laser within the melting laser can ensure spatter free process. This is applicable to area printing and can be potentially applied to other powder bed fusion processes as well.

### RELATED APPLICATION

The present disclosure is part of a non-provisional patent application claiming the priority benefit of U.S. Patent Application No. 63/773,185, filed on Mar. 17, 2025, which is hereby incorporated by reference in its entirety.

### TECHNICAL FIELD

The present disclosure relates generally to a system and method for additive manufacture and, more particularly, powder bed fusion using two-dimensional energy patterning to both print and mitigate spatter and sloshing during printing.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials. Using a range of feedstock or building block materials, commercial parts or prototypes can be manufactured using lasers, electron beams, or nozzles to drive the consolidation of the feedstock into fabricated parts. The feedstock can include powders, wirefeed, mixtures for extrusion to make green bodies, or photoreactive materials addressed with light or lasers.

Many additive manufacturing techniques require heating and even melting the precursor of the feedstock. In some additive manufacturing techniques, droplets can form and coalesce during this melting process. Occasionally these droplets can jump, breaking contact with the surface. This phenomenon is known as spatter. Uncontrolled spatter can be detrimental to part quality, density, and surface roughness. Additionally, spatter can undermine the integrity of the mechanical properties of the part. Another feature of additive manufacturing that can affect the quality of the part is sloshing. Sloshing occurs when the temperature gradient within the melt pool is non uniform over a surface area. Sloshing can similarly undermine many aspects of part quality including but not limited to surface roughness.

### SUMMARY

A method of additive manufacturing can comprise providing a precursor on a print plate, preforming a pre-melting heating of the precursor wherein the precursor is heated to a uniform layer point, and uniformly melting a top layer of precursor using an energy source. In some embodiments the method can further comprise melting the precursor into a state of melt pool spreading before a critical time is reached. In some embodiments the method can further comprise pre-sintering the precursor. In some embodiments the method could further comprise using a high flux laser within the energy source at a critical time.

### BRIEF DESCRIPTION OF DRAWINGS

Non-limiting and non-exhaustive embodiments of the present disclosure are described with reference to the following figures, wherein like reference numerals refer to like parts throughout the various figures unless otherwise specified.

FIG. 1 illustrates a PRIOR ART embodiment of a slow melting process of a precursor that results in formation of spatter.

FIG. 2A illustrates an embodiment of a build plate with an unmelted top layer of precursor.

FIG. 2B illustrates an embodiment of a build plate with a sintered top layer of a precursor.

FIG. 2C illustrates an embodiment of a build plate with a fully melted top layer of precursor in a state of melt pool spreading.

FIG. 3A illustrates an embodiment of a sidewall of a part manufactured without pre-sintering and displaying significant spatter.

FIG. 3B illustrates an embodiment of a sidewall of a part manufactured with pre-sintering displaying minimal spatter.

FIG. 4A illustrates an embodiment of cross-sectional post manufacturing analysis of a part manufactured without melting using a high flux laser.

FIG. 4B illustrates an embodiment of cross-sectional post manufacturing analysis of a part manufactured by melting using a high flux laser.

FIG. 5A illustrates an embodiment of a top view of a micrograph of a part manufactured without implementing a spatter reduction method.

FIG. 5B illustrates an embodiment of a top view of a micrograph of a part manufactured with a spatter reduction method.

FIG. 6A illustrates an embodiment of a non-irradiation zone within a tile on a build plate.

FIG. 6B illustrates an embodiment of a spatial flux distribution of an energy source.

FIG. 6C illustrates a graph of an embodiment of a temporal pulse shape of a pulse from an energy source.

FIG. 7 illustrates an additive manufacturing system able to provide one or two dimensional light beams to a print bed that can be used in conjunction with powder dispersion assembly embodiments described herein;

FIG. 8 illustrates a method of operating a print bed based additive manufacturing system able to provide one or two dimensional laser light beams that can be used in conjunction with powder dispersion assembly embodiments described herein; and

FIG. 9 illustrates an additive manufacturing system that can be used in conjunction with embodiments described herein.

### DETAILED DESCRIPTION OF DRAWINGS

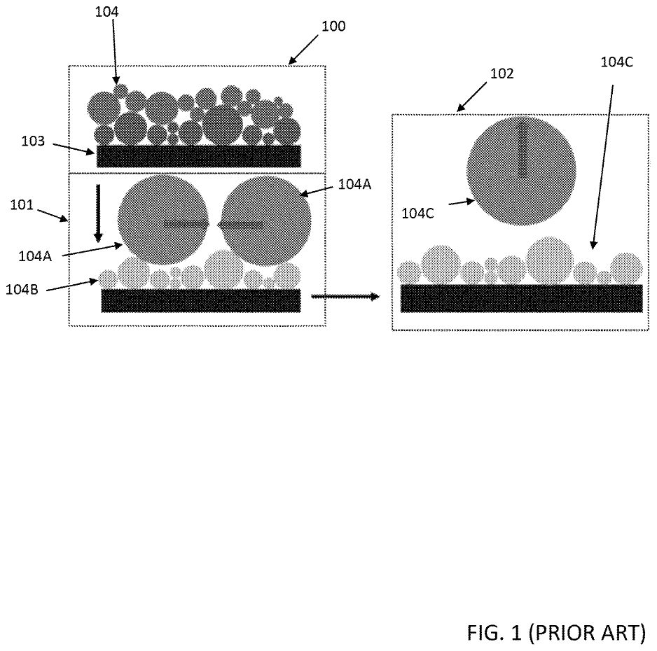

FIG. 1 illustrates PRIOR ART embodiment of a slow melting process of a material provided as a precursor 104. The precursor 104 can be plastic, metal, glass, ceramic, crystal, other meltable material, or a combination of meltable and unmeltable materials (i.e., plastic and wood or metal and ceramic). In various examples the precursor can be an elemental precursor, an alloy, a metallic compound, or other compound material. In some embodiments the precursor can be composed of heterogeneously sized materials (as shown in FIG. 1) or alternatively can be composed of homogeneously sized particles, pellets, or powders.

In some embodiments a build plate 103 is provided that is coated in a solid precursor 104. After the precursor 104 is provided (indicated within dotted box outline 100), the precursor 104 can then be heated and sintered by an energy source. During the heating and sintering process (indicated within dotted box outline 101), the molten precursor either uniformly melts onto the build plate 103 as displayed in 104B or forms into molten precursor droplets 104A. During droplet jumping (indicated within dotted box outline 102), these precursor droplets 104A can coalesce into jumping droplets 104C and the droplets will “jump” away from the uniformly melted precursor 104B. The droplets 104C jump from the substrate as the surface energy is transformed into kinetic energy during coalescence of precursor droplets 104A. Unfortunately, droplet jumping 102 results in spatter which can be detrimental to part surface roughness, density, and porosity leading to poorly performing manufactured parts with decreased elasticity, tensile strength, and torsional strength. Spatter formed can be in the range of 100 to 1000 micrometers.

A number of different mechanisms can cause droplet formation and spatter including melt pool instability and vapor induced entrainment effects. In the former surface convection flows, for example the Maragoni effect, can drive recirculation where hot metal near the surface of the melt pool breaks away from the more viscous body of the metal below. In addition. At the contact point between the unmelted precursor and the energy source, the rapid melting may cause the material to reach boiling point causing a gas plume to be created, exerting a pressure under the surface point exerting a pressure under the melting area and creating a depression. The result is similar to a ‘bow wave” when a boat moves through water causing hot, low viscosity material to move ahead of the energy source and spill over. When this material thins and elongates, it can break up into spatter particles on the precursor bed. In addition, the vapor may be sufficient to pick up and carry unmelted particles of material, so called vapor entrainment.

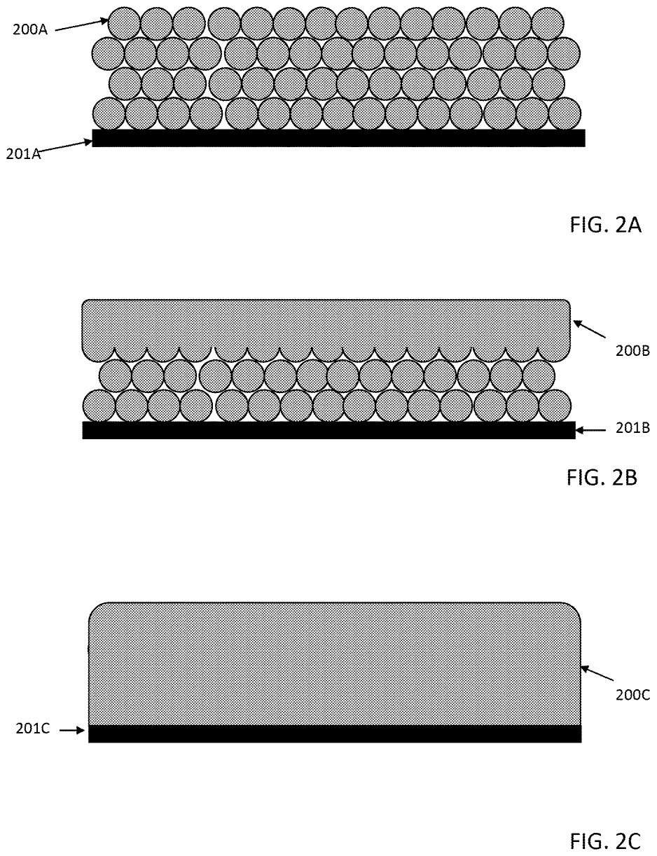

FIG. 2A illustrates an embodiment of a build plate with an unmelted top layer of precursor 200A on a build plate 201A. In some embodiments the precursor 200A particles can be uniform in size. In other embodiments the precursor 200A particles can vary in size. Additionally, the distribution of the precursor 200A particles can be uniform in some embodiments but can be variable in other embodiments. FIG. 2A displays an embodiment of the precursor 200A prior to any heating from the energy source.

FIG. 2B illustrates an embodiment of a build plate 201B with a sintered top layer of a precursor 200B. In this embodiment the top layer of precursor 200B is not fully melted but partially melted or sintered. Sintering a portion of a top layer 200B of precursor allows for a more uniform melting of the precursor due to effective heat conduction between the particles. The more uniform melting helps prevent the coalescence of precursors into discrete droplets capable of coalescing with one another and creating spatter. In some embodiments the sintering can be done using a combination of a low fluence diode laser and high flux laser which melts the powder. In some embodiments the sintering can be done in a few microseconds. In some embodiments the sintering and melting can be done using a singular pulse. In other embodiments the sintering and melting can be accomplished by a pulse train or a series of pulses. A material reaches its sintering point when the loose solid becomes more compact and begins to melt but not to the point of complete liquification. In some embodiments, the precursor 200B can comprise a heterogeneous precursor comprising a combination of elements and or compounds or a homogenous precursor comprising a single element or compound. In embodiments with a heterogeneous precursor, the sintering phase can comprise heating the precursor to a melting point of one of the compounds or elements. In some embodiments the precursor 200B can be heated to such a point that the particles have not melted but the overall volume of the precursor has begun to decrease.

FIG. 2C illustrates an embodiment of a build plate 201C where a precursor has been melted using an energy source into a melt pool 200C. The precursor can be transformed into the melt pool 200C by pre-sintering, sintering or further heating the precursor up to a critical melting or pre-melting point before spatter occurs. In some embodiments, a recoil pressure can be introduced into the system to control spatter at a critical time prior to spatter formation. For example, the precursor can be sintered or pre-sintered to a critical point using a low fluence diode heating laser and then a critical point where spatter formation is determined to be likely to occur a high flux laser pulse can be introduced to create a recoil pressure to prevent spatter formation. Either or both of the low fluence diode heating laser and/or the high flux laser may be in the form of a two-dimensional image or a two-dimensional fully grayscale image.

In some embodiments, the energy source can continue to heat the precursor 200C to fully melt the precursor. In some embodiments, the top layer can be pre-sintered and not fully melted and in other embodiments the top layer can be fully melted using a singular laser pulse. In some embodiments the energy source can be configured to melt the precursor using a singular laser pulse. In some embodiments the energy source could melt using a series of singular laser pulses sequentially timed out relative to one another. In other embodiments the singular laser pulses could further comprise a high flux laser pulse configured to melt the precursor prior to the onset of droplet jumping and spatter formation.

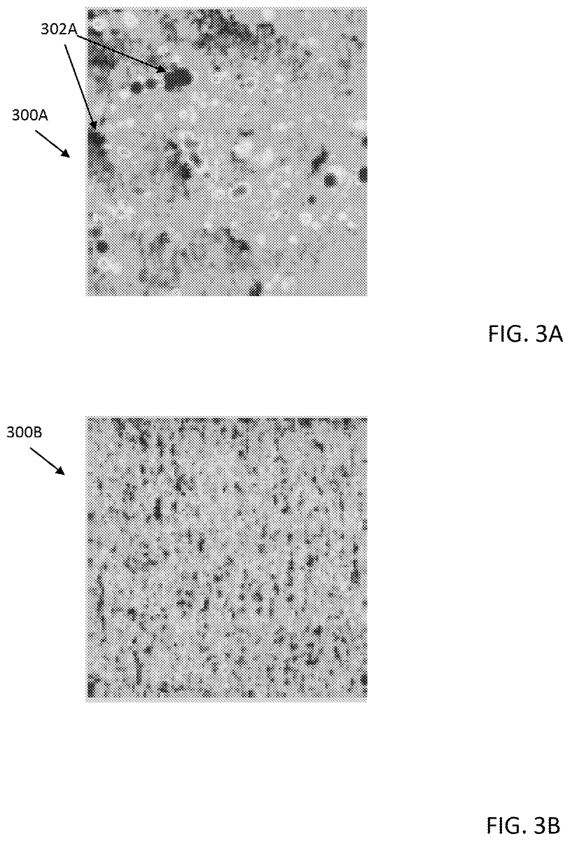

FIG. 3A illustrates an example image 300A of a sidewall of a part manufactured without pre-sintering displaying significant spatter. FIG. 3A displays several large spatter marks 302A clustered in different sections of the part to be manufactured. In embodiments with significant clustered spatter 302A, as seen in FIG. 3A, the structural integrity of the part is flawed with weak points at the spatter 302A clusters.

FIG. 3B illustrates an example image 300B of an embodiment of a sidewall of a part manufactured using pre-sintering. This embodiment displays a part manufactured with sintering that displays minimal spatter. Additionally, the spatter of the part is insignificant and evenly dispersed throughout the part. In this embodiment, the part has improved structural integrity and fewer weak spots given the even dispersion of the insignificant spatter. In this embodiment the part has a significantly reduced porosity compared to the part manufactured without pre-sintering. In various embodiments appropriate sintering parameters can be a diode laser of 1-1000 kW/cm2 for 1-10 ms and a high flux laser of 10-500 J/cm2. In some embodiments the diode laser fluence can range from 0.1-10 kJ/cm2.

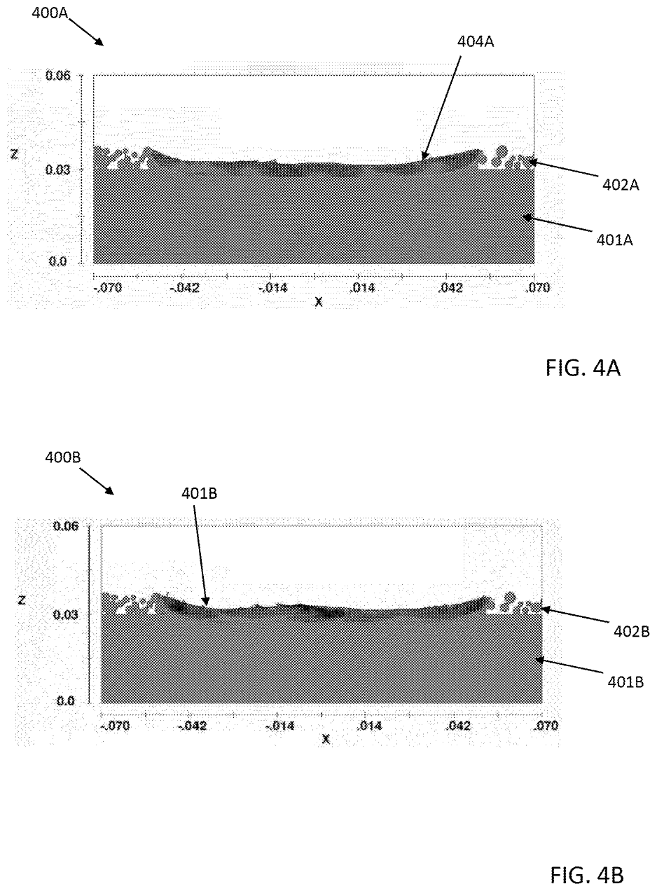

FIG. 4A illustrates an example image 400A of an embodiment of a cross-sectional post manufacturing analysis of a part manufactured without melting using a high flux laser. In this embodiment a precursor 402A on a build plate 401A was heated into part 404A. In this embodiment the part is heated with only a low fluence diode laser. As can be seen in FIG. 4A, the part 404A has several large light gray spots indicating the non-uniform internal composition of the part. The non-uniform composition leads to poor structural integrity of the part including decreased elasticity, tensile strength, and torsional strength relative to a part with a more uniform composition.

FIG. 4B illustrates an example image 400B of an embodiment of cross-sectional post manufacturing analysis of a part manufactured by melting using a high flux laser. In this embodiment the precursor 402B on the build plate 401B was heated into part 404B. In this embodiment the energy source can comprise both the low fluence diode laser and a high flux laser. In some embodiments the combined fluence of the flux laser and high flux laser can be. For example, the high flux laser can be a high-power fiber laser. In some embodiments the high flux laser can be initiated 0.05-4 ms after the low fluence laser. However, the high flux laser pulse can be fully contained within the pulse profile of the low fluence laser. In some embodiments the critical time for implementing the high flux laser can vary based on the power flux of the high flux laser. In this embodiment the part 404B has a more uniform composition with fewer and smaller light gray weak spots relative to the embodiment in FIG. 4A where the precursor was melted without a high fluence laser. In some embodiments the energy source can further comprise a high flux laser.

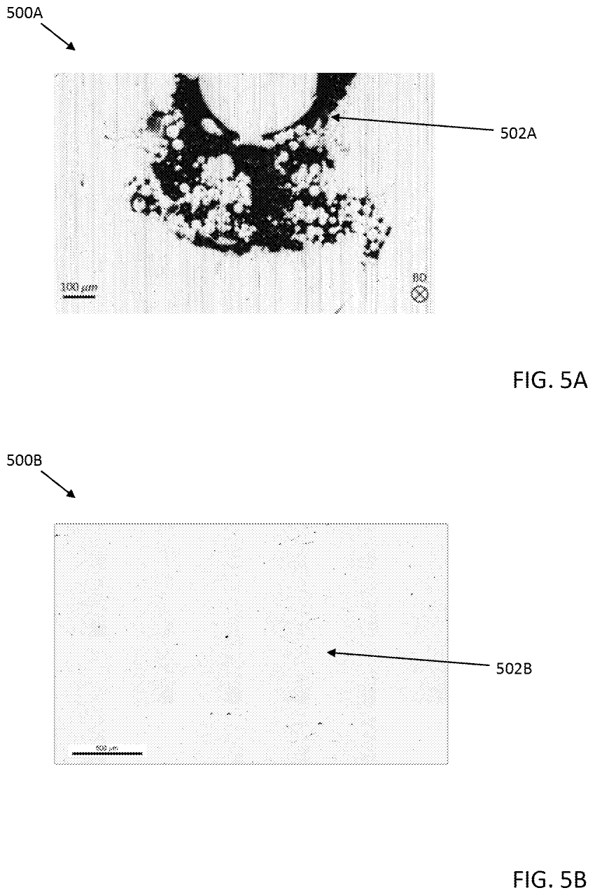

FIG. 5A illustrates an image 500A of an embodiment of a top view of a micrograph of a part manufactured without implementing a spatter reduction method. The part has significant spatter leading to a very poor metal quality and flaws 502A. The micrograph displays the detrimental effect of even minimal spatter on part porosity. The significant flaws 502A can decrease the tensile and torsional strength of the part significantly. Additionally, significant spatter can be detrimental to the surface quality of the part as seen by the flaws 502A.

FIG. 5B illustrates an image 500B of an embodiment of a top view of a micrograph of a part manufactured with a spatter reduction method. Contrasted with the micrograph of FIG. 5A, the micrograph of the part manufactured with spatter reduction methods displays a more uniform part with significantly fewer flaws 502B and smaller flaws 502B.

In some embodiments the assembly can further comprise a camera configured to record the melting process. Analysis of the recording will allow the operator to determine the critical point for the melting process so as to avoid spatter. In some embodiments the camera can be a high-speed camera configured to record at a high frame rate. In some embodiments the critical point of the precursor depends on the laser strength, the precursor material, and the thickness of the precursor layer. In some embodiments the critical times calculated from the recording analysis can be stored in a database. In some embodiments that database can be connected to a powder bed fusion manufacturing assembly as a manufacturing setting to enable faster turnover between builds and improved manufacturing efficiency. In some embodiments the database can be organized by a variety of factors including but not limited to precursor material, laser strength, and thickness of the precursor layer to be melted. In various embodiment the critical point can be determined by simulation, experimentation or some combination or simulation or experimentation. The critical point can be dependent on a plurality of parameters including precursor material, part geometry, flux of energy source, fluence of energy source, two-dimensional pattern, or gray scaling of energy source. For example, inputs including data from high speed camera feeds, previous build parameters, analysis of previously built parts, or laser parameters could be used as input into a multiphysics model to determine the most likely critical point and best pulse time, shape, two-dimensional pulse structure etc. Machine learning or other feedback mechanisms could be used to refine the inputs over time.

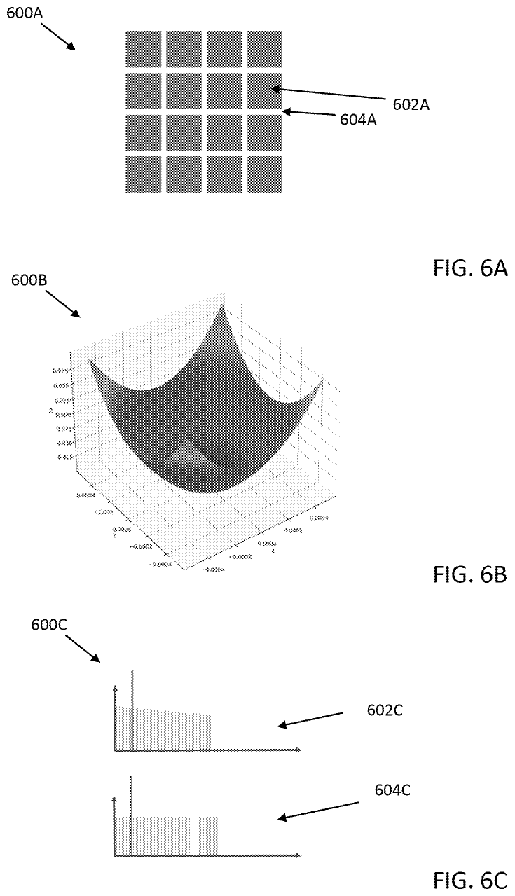

FIG. 6A illustrates an image 600A of an embodiment of a non-irradiation zone within a tile on a build plate. During melt, pool spreading temperature gradients can form and lead to mass transfer and sloshing due to a large irradiation area. The laser pulse area can be arranged to provide radiation zones 602A along with non-irradiation zones 604A provided in between the radiation zones 602A in some embodiments. In some embodiments the non-irradiation zone can be configured as lanes or regions that introduce discontinuity to the melt pool. In some embodiments the discontinuity can be configured to dampen the melt flow. In some embodiments the non-irradiation zones 604A have a spacing gap that can be in less than a micron, less than 10 microns, or other suitable range. In some embodiments the spacing gap can be adjusted depending on the material properties of the precursor. In some embodiments after manufacturing the manufactured part can be analyzed and the energy source parameters used can be saved so as to form a database to improve consistency in part production. In some embodiments this laser-based approach to improve part surface quality can be combined with material-based approaches that adjust viscosity and surface tension of the precursor in melt pool spreading.

FIG. 6B illustrates an image 600B of an embodiment of a spatial flux distribution of an energy source having higher spatial flux at edges and corners of a tile. In some embodiments the spatial flux distribution can be determined through grey scaling. In some embodiments the spatial flux distribution can be augmented to optimize the uniformity of the thermal gradient dependent on the cross-sectional geometry of the laser pulse. In some embodiments the spatial flux distribution can be augmented dependent on the material of the precursor. In some embodiments the spatial flux distribution can be augmented depending on the internal and/or external geometry of the part to be manufactured.

FIG. 6C illustrates representative graphs 600C of embodiments of a temporal pulse shape 602C and 604C of a pulse from an energy source. The y-axis of the graphs represents pulse power, and the x-axis of graphs represents time. In some embodiments the power of temporal pulse can decrease or increase with respect to time. In other embodiments the temporal pulse can maintain the same power throughout the pulse time. In some embodiments the temporal pulse can further comprise a second pulse following an initial pulse. In some embodiments the temporal shape of the pulse can be changed dependent on precursor or part geometry to optimize the uniformity of the temperature gradient. In some embodiments the temporal pulse shape can be augmented to control the rate of solidification. In some embodiments the tailored temporal pulse shape can further comprise a timed high flux laser configured to solidify the precursor in the melt pool phase prior to droplet formation and spatter production, and the time for the timed pulse is denoted by the red line along the x-axis.

In some embodiments the manufacturing method can comprise any combination of defining a non-irradiation zone, defining a spatial flux, providing a temporal pulse, melting the precursor prior to droplet jumping, pre-sintering a top layer of the precursor, timing a high flux laser within an energy source, and any other material-based method of providing a uniform temperature gradient or preventing droplet formation and spatter.

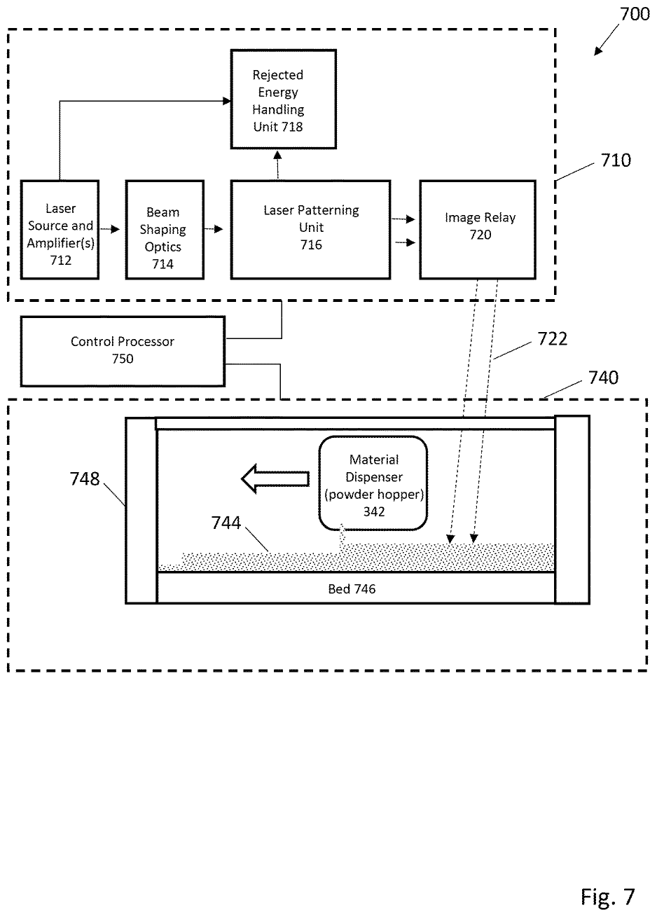

In an embodiment illustrated with respect to FIG. 7, additive manufacturing systems suitable for providing spatter free or reduced spatter parts, including the described embodiments, can be represented by various modules that form additive manufacturing method and system 700. As seen in FIG. 7, a laser source and amplifier(s) 712 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulse source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g., fiber), Semiconductor (e.g., diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO₄) laser, Neodymium doped yttrium calcium oxoborateNd: YCa4O(BO₃)3 or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAgG) laser, Chromium ZnSe (Cr:ZnSe) laser, Cerium doped lithium strontium (or calcium)aluminum fluoride(Ce:LiSAF, Ce:LiggCAF), Promethium 147 doped phosphate glass(147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 7, the additive manufacturing system 700 can use lasers able to provide one-or two-dimensional directed energy as part of an energy patterning system 710 In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 710 uses laser source and amplifier(s) 712 to direct one or more continuous or intermittent energy beam(s) toward beam shaping optics 714. After shaping, if necessary, the beam is patterned by an energy patterning unit 716, with generally some energy being directed to a rejected energy handling unit 718. Patterned energy is relayed by image relay 720 toward an article processing unit 740, in one embodiment as a two-dimensional image 722 focused near a bed 746. The article processing unit 340 has plate or bed 746 (with walls 748) that together form chamber containing material 744 (e.g., a metal powder) dispensed by powder hopper or other material dispenser 742. Dispensed powder can be created or recycled as discussed in this disclosure. Patterned energy, directed by the image relay 720, can melt, fuse, sinter, amalgamate, change crystal structure, influence stress patterns, or otherwise chemically or physically modify the dispensed and distributed material 744 to form structures with desired properties. A control processor 750 can be connected to variety of sensors, actuators, heating or cooling systems, monitors, and controllers to coordinate operation of the laser source and amplifier(s) 712, beam shaping optics 714, laser patterning unit 716, and image relay 720, as well as any other component of system 700. As will be appreciated, connections can be wired or wireless, continuous or intermittent, and include capability for feedback (for example, thermal heating can be adjusted in response to sensed temperature).

In some embodiments, beam shaping optics 714 can include a great variety of imaging optics to combine, focus, diverge, reflect, refract, homogenize, adjust intensity, adjust frequency, or otherwise shape and direct one or more laser beams received from the laser source and amplifier(s) 712 toward the laser patterning unit 716. In one embodiment, multiple light beams, each having a distinct light wavelength, can be combined using wavelength selective mirrors (e.g., dichroic) or diffractive elements. In other embodiments, multiple beams can be homogenized or combined using multifaceted mirrors, microlenses, and refractive or diffractive optical elements.

The laser patterning unit 716 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror, or micro-mirror systems, piezo or micro-actuated optical systems, fixed or movable masks, or shields, or any other conventional system able to provide high intensity light patterning.

Rejected energy handling unit 718 can be used to disperse, redirect, or utilize energy not patterned and passed through the image relay 720. In one embodiment, the rejected energy handling unit 718 can include passive or active cooling elements that remove heat from both the laser source and amplifier(s) 712 and the laser patterning unit 716. In other embodiments, the rejected energy handling unit can include a “beam dump” to absorb and convert to heat any beam energy not used in defining the laser pattern. In still other embodiments, rejected laser beam energy can be recycled using beam shaping optics 714. Alternatively, or in addition, rejected beam energy can be directed to the article processing unit 740 for heating or further patterning. In certain embodiments, rejected beam energy can be directed to additional energy patterning systems or article processing units.

Image relay 720 can receive a patterned image (either one or two-dimensional) from the laser patterning unit 716 directly or through a switchyard and guide it toward the article processing unit 740. The image relay can include telescope systems such as disclosed herein, as well as a range of other mirrors or optical elements.

The material dispenser 742 (e.g., powder hopper) in article processing unit 740 (e.g., cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 746.

In addition to material handling components, the article processing unit 740 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2,C₄H₇, 1,3-C₄H₆, 1,2-C4H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants, or large inert molecules (including but not limited to sulfur hexafluoride) can be used. An enclosure atmospheric composition to have at least about 1% He by volume (or number density), along with selected percentages of inert/non-reactive gases can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ~0.1-0.2 cubic meters (i.e., greater than 100-200 liters or heavier than 500-1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that support a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems are also used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having an article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically, and the results of characterizations result in adjustments to the powder bed fusion process. The ingester system can optionally be used for one or more of audit, process adjustments, or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that can be difficult or impossible for a human to move is described. The manipulator device can grasp various permanent or temporary additively manufactured manipulation points on a part to enable repositioning or maneuvering of the part.

Control processor 750 can be connected to control any components of additive manufacturing system 700 described herein, including lasers, laser amplifiers, optics, heat control, build chambers, and manipulator devices. The control processor 750 can be connected to a variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 750 is provided with an interface to allow input of manufacturing instructions. Use of a wide range of sensors allows various feedback control mechanisms that improve quality, manufacturing throughput, and energy efficiency.

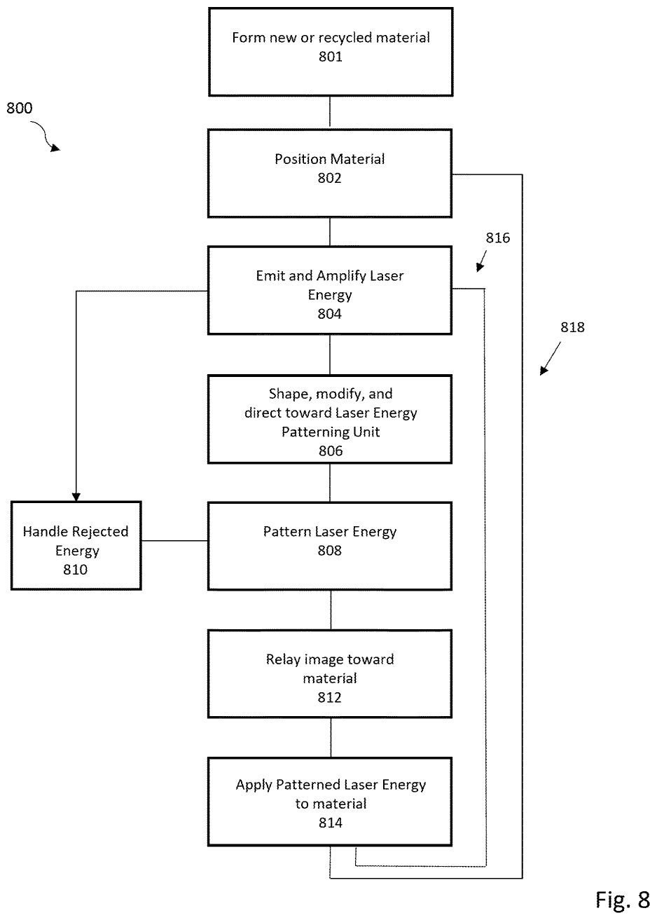

One embodiment of operation of a manufacturing system suitable for additive or subtractive manufacture is illustrated in FIG. 8. In this embodiment, a flow chart 800 illustrates one embodiment of a manufacturing process supported by the described optical and mechanical components. In step 801, material powder created or recycled as discussed in this disclosure is formed. In step 802, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 804, unpatterned laser energy is emitted by one or more energy emitters, including but not limited to solid state or semiconductor lasers, and then amplified by one or more laser amplifiers. In step 806, the unpatterned laser energy is shaped and modified (e.g., intensity modulated or focused). In step 808, this unpatterned laser energy is patterned, with energy not forming a part of the pattern being handled in step 810 (this can include conversion to waste heat, recycling as patterned or unpatterned energy, or waste heat generated by cooling the laser amplifiers in step 804). In step 812, the patterned energy, now forming a one or two-dimensional image is relayed toward the material. In step 814, the image is applied to the material, either subtractively processing or additively building a portion of a 3D structure. For additive manufacturing, these steps can be repeated (loop 818) until the image (or different and subsequent image) has been applied to all necessary regions of a top layer of the material. When application of energy to the top layer of the material is finished, a new layer can be applied (loop 816) to continue building the 3D structure. These process loops are continued until the 3D structure is complete, when remaining excess material can be removed or recycled.

In some embodiments, an additive manufacturing system can include a light valve and a switchyard system enabling reuse of patterned two-dimensional energy. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials. In one switchyard embodiment, an additive manufacturing system has an energy patterning system with a laser and amplifier source that directs one or more continuous or intermittent laser beam(s) toward beam shaping optics. Excess heat can be transferred into a rejected energy handling unit that can include an active light valve cooling system. After shaping, the beam is two-dimensionally patterned by an energy patterning unit, with generally some energy being directed to the rejected energy handling unit. Patterned energy is relayed by one of multiple image relays toward one or more article processing units, typically as a two-dimensional image focused near a movable or fixed height bed. The bed can optionally be inside a cartridge that includes a powder hopper or similar material dispenser. Patterned laser beams, directed by the image relays, can melt, fuse, sinter, amalgamate, change crystal structure, influence stress patterns, or otherwise chemically or physically modify the dispensed material to form structures with desired properties.

In some embodiments, the rejected energy handling unit can have multiple components to permit reuse of rejected patterned energy. Coolant fluid from the laser amplifier and source can be directed into one or more of an electricity generator, a heat/cool thermal management system, or an energy dump. Additionally, relays can respectively transfer energy to the electricity generator, the heat/cool thermal management system, or the energy dump. Optionally, relay can direct patterned energy into the image relay for further processing. In other embodiments, patterned energy can be directed by relay for insertion into the laser beam(s) provided by laser and amplifier source. Reuse of patterned images is also possible using image relays. Images can be redirected, inverted, mirrored, sub-patterned, or otherwise transformed for distribution to one or more article processing units. Advantageously, reuse of the patterned light can improve energy efficiency of the additive manufacturing process, and in some cases improve energy intensity directed at a bed or reduce manufacture time.

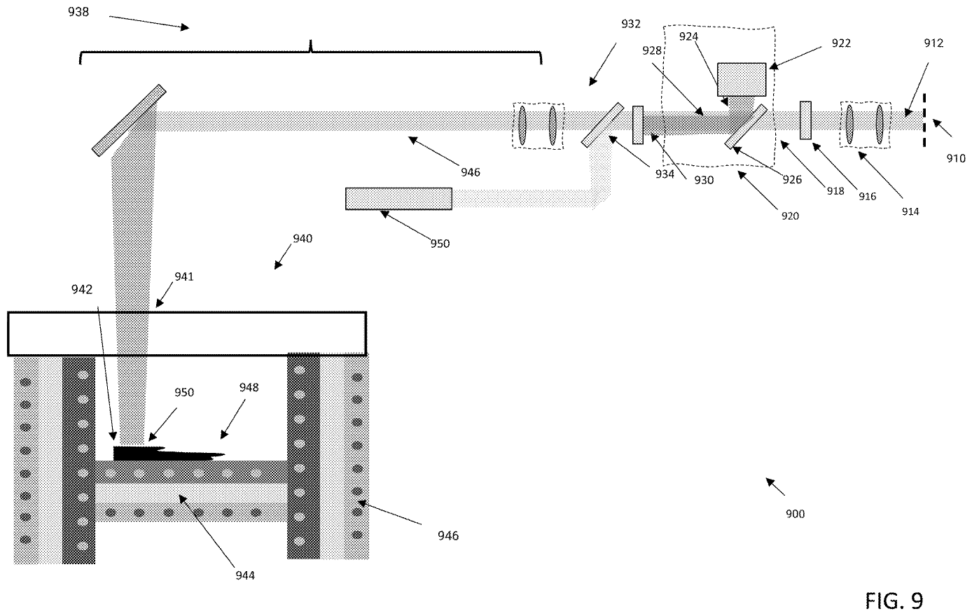

Another embodiment of a manufacturing system suitable for additive manufacture and supporting a slow melting process for a precursor and controlled formation of spatter is illustrated in FIG. 9. As seen in FIG. 9, one or more laser sources and amplifiers 910 can be constructed as a continuous or pulsed laser. The one or more laser sources and amplifiers can emit a red, or infra-red beam in various embodiments. The one or more laser sources and amplifier can comprise a heating laser or a high energy pulsed laser. In some examples a first beam line one or more laser sources and amplifiers 910 comprises a heating laser, for example one or more diode lasers or fiber lasers and a in a second beam line one or more laser sources and amplifiers 910 comprises a high energy pulsed laser. For example, the laser source can be a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulse source which uses a Pockels cell can be used to create an arbitrary length pulse train.

The beam 912 emitted from the one or more laser sources 910 can pass through a series of relay optics 914, said relay optics can comprise one or more lenses, mirrors, fibers, or other systems capable of relaying laser energy. Said laser energy can then enter a laser homogenizer 916. Laser homogenizer 916 is configured to condition beam 912 to produce a more uniform beam profile. Laser homogenizer 916 may include one or more lenslet arrays or other systems to distribute energy across the beam profile. Laser homogenizer 916 may further include one or more optical systems to shape the beam, for example to produce a square beam.

A shaped beam 918 emitted from laser homogenizer 916 can subsequently enter a patterning unit assembly 920. A single beam line 918 is shown in FIG. 9, however one or more beam lines may enter the patterning unit assembly 920. In some examples, each beam line may enter a separate patterning assembly, in another embodiment each beam line may enter a single patterning unit assembly. Each beam line 918 can comprise a heating laser, a high power pulsed laser, patterning laser, or a combination thereof.

Patterning unit assembly 920 can include one or more projectors 922 emitting patterned blue light. For example, light with wavelength of 430-450 nm. The blue light emitter can be a DLP, LED, laser, or other digital projector arranged to emit patterned light in the blue spectrum. The blue light, in some embodiments, can be the same size and shape as the shaped beam 918. A beam combiner 926 can be used to combine the shaped laser light 918 from the one or more beam lines with the blue light 924, for example beam combiner 926 can transmit the shaped laser light 918 and reflect the blue light 924 to form a combined beam 928.

The combined beam 928 can enter a spatial light modulator (SLM) 930, e.g., a liquid crystal optically addressed light valve (“OALV”, “light valve”) that controls the polarization of the combined beam in a spatially varying manner. In other embodiments the light valve can control the phase or intensity variation of the combined beam or some combination of polarization, phase, and intensity. In alternative embodiments, fixed or variable masks or other equivalent methods of selectively blocking light may be used.

In an example, the light valve is formed of a sandwich of transparent substrates. The substrates can be bonded together at the edges, leaving a very small space (e.g., few micron space) between the substrates that is filled with liquid crystal. Several coatings can be applied to the substrate, for example anti-reflective coatings. The light valve may be a transmissive light valve or reflective light valve. The liquid crystal within the light valve activates when exposed to blue light, imparting a first polarization on areas of the combined beam 928 that contain blue light, and a second polarization on areas of the combined beam 928 that do not contain blue light. The light valve can withstand a high pulsed laser fluence and for example can be able to withstand a laser fluence of greater than 10 J/cm2 for milliseconds for millions of laser pulses. The light valve can be able to switch between different pulses of patterned light at least 20 Hz, i.e., the liquid crystal can have a relaxation time of 50 milliseconds or less.

Polarized light 932 from the light valve enters a polarizer 934 which rejects the second polarized light. The polarizer 934 can transmit light of the first polarization and reflect light of the second polarization or vice versa. In various embodiments rejected light, not used in the pattern is directed toward a beam dump, light recycling system, or other light handling system.

Patterned energy 936 can relayed by one or more further relay optics 938 toward an article processing unit 940, in one embodiment, as a two-dimensional image 942 focused near a bed 944. In one embodiment, the patterned energy comprises a single pulse of high-power patterned laser energy. In another embodiment, the patterned energy can comprise a single pulse of patterned laser energy from a heating laser. In alternative embodiments, the patterned energy can comprise a combination of high-power patterned laser energy and patterned laser energy from a heating laser, where the high-powered patterned laser energy can have at least 10× the fluence of the patterned laser energy from the heating laser, and the pulse time of the heating laser is at least 10× the pulse time of the high power laser.

The article processing unit 940 can include a removable cartridge. The article processing unit 940 has plate or bed 944 with walls 946 that together form a sealed cartridge chamber containing material 948 (e.g., a metal powder, for example, metal powder my include alloys such as steels, Inconel, aluminum alloys, titanium alloys, or metal elements such as Iron, Copper, Aluminum, Titanium, etc.) dispensed by powder hopper or other material dispenser. Dispensed powder can be created or recycled as discussed in this disclosure. Patterned energy, directed by the image relay 936, can melt, fuse, sinter, amalgamate, change crystal structure, influence stress patterns, or otherwise chemically or physically modify the dispensed and distributed material 948 to form structures with desired properties. In various examples, 3-D objects can be formed by melting metal powder by the patterned energy in a sequential series of 2-D patterned areas “tiles” to form a first layer of melted metal, a further layer of metal powder can then be spread, and a further sequential sequence of 2-D patterned tiles can be melted, repeating the spreading in melting until the object is formed. In some embodiments the tile may be the same pattern repeating for some or all of the print, in others the tile may not repeat. A control processor 950 can be connected to variety of sensors, actuators, heating or cooling systems, monitors, and controllers to coordinate operation of the laser source and amplifier(s) 910, relay optics 914, laser patterning assembly 920, and relay optics 938, as well as any other component of system 900. As will be appreciated, connections can be wired or wireless, continuous or intermittent, and include capability for feedback (for example, thermal heating can be adjusted in response to sensed temperature).

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A method of additive manufacturing comprising:
providing a precursor on a print plate;
preforming a pre-melting heating of the precursor using a first energy source, wherein the precursor is heated into a uniform layer to a temperature below a critical time of spatter droplet formation; and
melting a top layer of precursor into a uniform layer using a further energy source having a flux greater than that provided by the first energy source.

2. The method of claim 1 wherein the melting of a top layer of precursor into a uniform layer further comprises melting the precursor into a state of melt pool spreading before a critical time is reached.

3. The method of claim 2, wherein the critical time is a time before droplet jumping occurs.

4. The method of claim 1 wherein the energy source further comprises a two-dimensional patterned laser.

5. The method of claim 2 wherein the critical time is less than 1 millisecond.

6. The method of claim 1 wherein the precursor is a powder.

7. The method of claim 1 wherein the pre-melting of the top layer of precursor comprises sintering the precursor.

8. The method of claim 1 wherein the first energy source comprises a low fluence diode laser and the further energy source comprises a high-power laser.

9. The method of claim 7 wherein the sintering compacts and heats the powder to a temperature below the melting point.

10. The method of claim 9 wherein melting the top layer of precursor into a uniform layer using a flux laser pulse at the critical time within the pulse of the low fluence diode laser.

11. The method of claim 1 further comprising recording the melting to determine the critical time.

12. The method of claim 11 further comprising compiling the critical time recordings into a database.

13. The method of claim 1 further comprising providing a uniform temperature gradient across the precursor.

14. The method of claim 1 further comprising defining a non-irradiation zone within a section of the print plate.

15. The method of claim 1 further comprising melting using a spatial flux distribution configured to provide the uniform temperature gradient.

16. The method of claim 1 further comprising tailoring a pulse shape of at least one of the first energy source and the further energy source to control the rate of solidification of the precursor.

17. A method of additive manufacturing comprising:
using a first energy source having a first energy flux to pre-melt a precursor into a first layer having a temperature below that needed for spatter droplet formation; and
melting a top layer of precursor into a second layer using a second energy source with a flux greater than the first energy flux, wherein the second energy flux suppresses spatter formation.
